(19) United States
(12) Patent Application Publication
(10) Pub. No.: US 2011/0320634 A1
(43) Pub. Date: Dec. 29, 2011

(54) CABLE MODEM AND CHANNEL SCANNING METHOD

(75) Inventor: CHUN-CHIEH YANG, Tu-Cheng (TW)

(73) Assignee: HON HAI PRECISION INDUSTRY CO., LTD., Tu-Cheng (TW)

(21) Appl. No.: 12/914,958

(22) Filed: Oct. 28, 2010

(30) Foreign Application Priority Data
Jun. 28, 2010 (CN) 201010210985.2

(51) Int. Cl. G06F 15/16

(52) U.S. Cl. 709/245; 375/222

(57) ABSTRACT

A cable modem and a channel scanning method of the cable modem include creating a black list to record invalid downstream channels, scanning downstream channels from the cable modem terminal system (CMTS), and ignoring the downstream channels stored in the black list. The creation of the black list includes obtaining Internet protocol (IP) addresses from the DHCP server and determining whether the IP addresses are successfully obtained, and in response to unsuccessfully obtaining the IP addresses, recording the locked downstream channel into the black list.

### BACKGROUND

1. Technical Field

Embodiments of the present disclosure relate to cable modems, and particularly to a cable modem and a channel scanning method of the cable modem.

2. Description of Related Art

In cable modem applications, a cable modem needs to scan downstream channels and lock valid downstream channels. The speed of this scanning operation is important for the cable modem, since it is directly related to the quality of service. However, the cable modem often takes a long time in establishing the bi-directional data communications, especially in scanning some invalid downstream channels.

Therefore, an unaddressed need to amend the aforementioned problem.

### BRIEF DESCRIPTION OF THE DRAWINGS

FIG. 1 is a schematic diagram of one exemplary embodiment of an environment of a cable modem of the present disclosure;

FIG. 2 is a flowchart of one exemplary embodiment of a channel scanning method of the cable modem of the present disclosure; and

FIG. 3 is a block diagram of one exemplary embodiment of the cable modem of the present disclosure.

### DETAILED DESCRIPTION

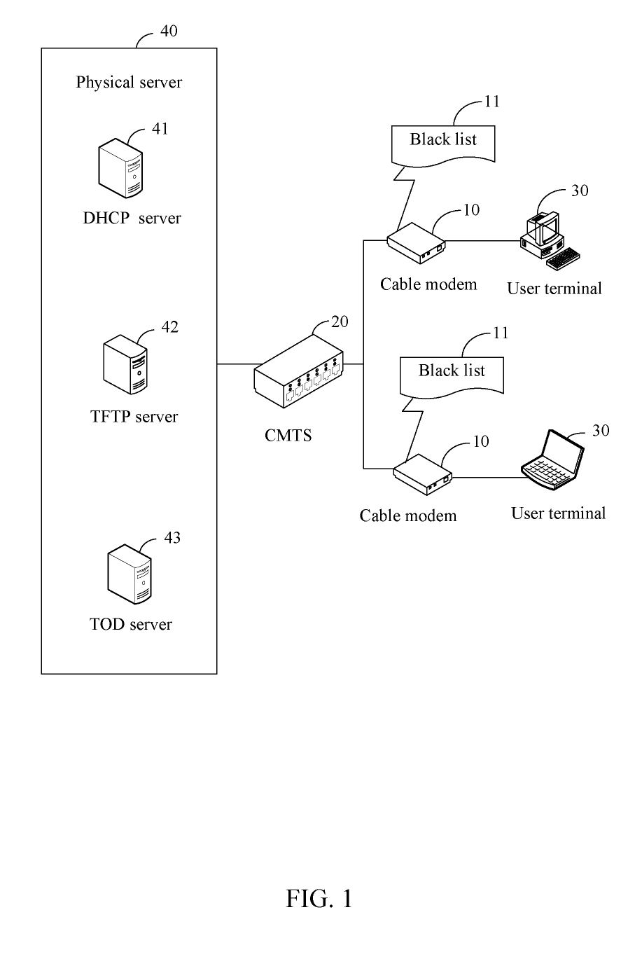

Referring to FIG. 1, a schematic diagram of one exemplary embodiment of an environment of a cable modem 10 is shown. In one embodiment, the cable modem 10 provides access service for a user terminal 30. The cable modem 10 communicates with a physical server 40 for obtaining interconnection resources. The term, “interconnection resources,” indicates resources to establish bi-directional data communications between the cable modem 10 and a cable modem terminal system (CMTS) 20.

The physical server 40 comprises a dynamic host configuration protocol (DHCP) server 41, a trivial file transfer protocol (TFTP) server 42, and a time of date (TOD) server 43. The DHCP server 41 assigns dynamic Internet protocol (IP) addresses for the cable modem 10. The TFTP server 42 records configuration files for the cable modem 10. The TOD server 43 provides current time and date for the cable modem 10 and the CMTS 20 to calibrate time and date. In one embodiment, the DHCP server 41, the TFTP server 42, and TOD server 43 may be integrated in one physical server 40.

In one embodiment, the cable modem 10 comprises a black list 11, which is a list that records invalid downstream channels. The term, “invalid downstream channels,” comprise channels without enough interconnection resources to establish bi-directional data communications between the cable modem 10 and the CMTS 20, such as failing to obtain IP addresses, configuration files, or failing to register with the CMTS 20.

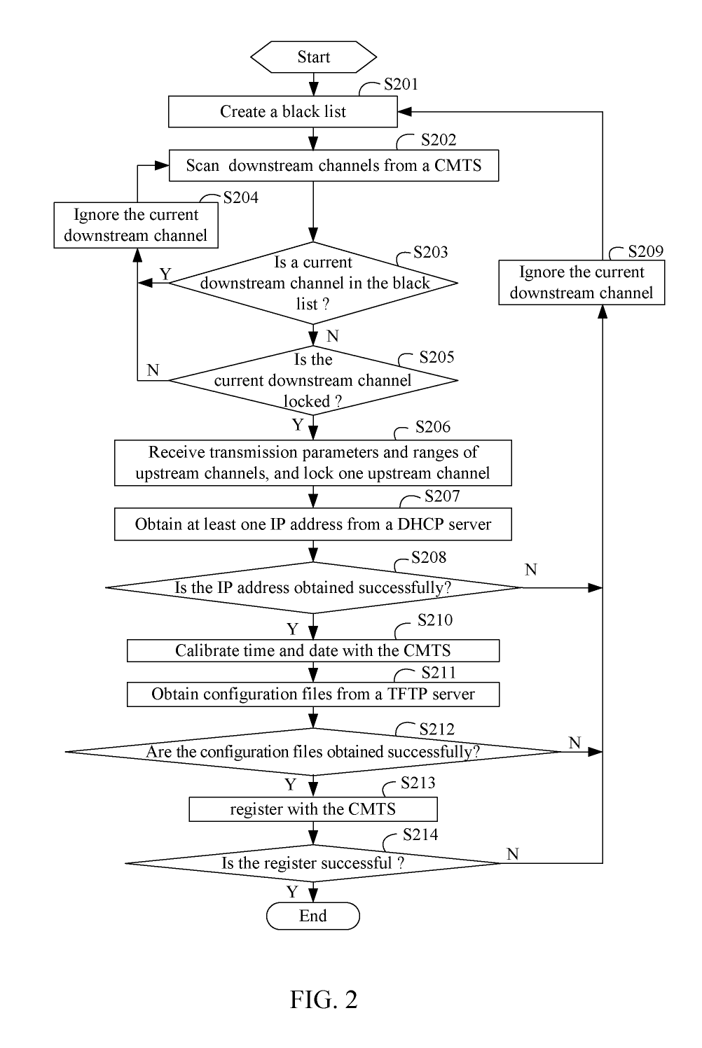

Referring to FIG. 2, a flowchart of one exemplary embodiment of a channel scanning method of the cable modem 10 is shown.

In block S201, the cable modem 10 creates the black list 11 which is a list that records invalid downstream channels. The term, “invalid downstream channels,” comprise channels without enough interconnection resources to establish bi-directional data communications between the cable modem 10 and the CMTS 20.

In block S202, the cable modem 10 scans downstream channels from the CMTS 20.

In block S203, the cable modem 10 determines whether a currently scanned downstream channel is in the black list 11 or not.

If the currently scanned downstream channel is in the black list 11, in block S204, the cable modem 10 ignores the currently scanned downstream channel, and executes block S202 to hop to a next downstream channel to scan. In one embodiment, the cable modem 10 ignoring the downstream channels in the black list 11 aims to avoid wasting time on scanning the invalid downstream channels.

If the currently scanned downstream channel is not in the black list 11, in block S205, the cable modem 10 determines whether the currently scanned downstream channel can be locked or not. In one embodiment, if the currently scanned downstream channel cannot be locked, it returns to block S204. If the currently scanned downstream channel can be locked, it goes to block S206. In one embodiment, the reason that the downstream channel cannot to be locked is only temporary, for example, signal to noise ratio (S/N) of the downstream channel is too low. Hence, the downstream channel should be just ignored, instead of recording in the black list 11.

In block S206, the cable modem 10 receives transmission parameters and ranges of upstream channels from the CMTS 20, and locks one upstream channel. Therefore, the cable modem 10 and the CMTS 20 can establish a connection over the locked downstream channel and the locked upstream channel. The cable modem 10 communicates with the physical server 40 via the connection with the CMTS 20.

In block S207, the cable modem 10 obtains at least one IP address from the DHCP server 41. In one embodiment, the at least one IP address comprises an IP address of the cable modem 10, an IP address of the TFTP server 42, and an IP address of the TOD server 43.

In block S208, the cable modem 10 determines whether the at least one IP address is successfully obtained from the DHCP server 41.

In response to unsuccessfully obtaining the at least one IP address, in block S209, the cable modem 10 ignores the currently scanned downstream channel, and records the ignored currently scanned downstream in the black list 11 in block S201.

In response to successfully obtaining the at least one IP address, in block S210, the cable modem 10 calibrates time with the CMTS 20. In one embodiment, the cable modem 10 and the CMTS 20 calibrate time by obtaining current time and date from the TOD server 43.

In block S211, the cable modem 10 obtains configuration files from the TFTP server 42, based on the IP address of the TFTP server 42 and the IP address of the cable modem 10.

In block S212, the cable modem 10 determines whether the configuration files are successfully obtained from the TFTP server 42. In response to unsuccessfully obtaining the configuration files, it turns to block S209. In response to successfully obtaining the configuration files, the flow goes to block S213.

In block S213, the cable modem 10 registers with the CMTS 20 based on the configuration files, and receives a register response from the CMTS 20.

In block S214, the cable modem 10 determines whether the register is successful or not. If the register is unsuccessful, the block S209 is repeated. If the register is successful, the cable modem 10 and the CMTS 20 establish the bi-directional data communication.

In one embodiment, the channel scanning method of the cable modem 10 scans channels fast, based on creation of the black list 11 to record the invalid downstream channels, and ignoring the downstream channels stored in the black list 11 to avoid wasting time.

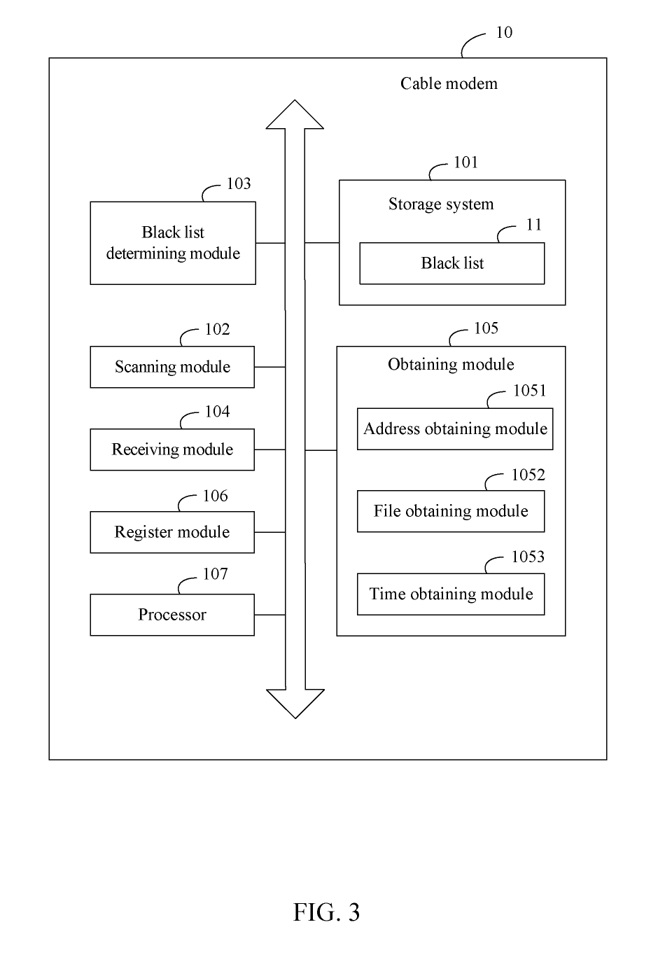

Referring to FIG. 3, a block diagram of one exemplary embodiment of the cable modem 10 is shown. The cable modem 10 comprises a storage system 101, a scanning module 102, a black list determining module 103, a receiving module 104, an obtaining module 105, a register module 106, and at least one processor 107.

The modules 102-106 may comprise computerized code in the form of one or more programs that are stored in the storage system 101. The computerized code includes instructions that are executed by the at least one processor 107 to provide functions for modules 102-106. In one embodiment, the storage system 101 may include hard disk drives, flash memories, RAM, ROM, caches, or external storage mediums.

The storage system 101 further comprises a black list 11, which is a list that records invalid downstream channels. As mentioned above, the term, “invalid downstream channels,” comprise channels without enough interconnection resources to establish bi-directional data communications between the cable modem 10 and the CMTS 20, such as failing to obtain IP addresses, configuration files, or failing to register with the CMTS 20.

The scanning module 102 scans downstream channels from the CMTS 20.

The black list determining module 103 determines whether a currently scanned downstream channel is in the black list 11 or not. If the currently scanned downstream channel is in the black list 11, the black list determining module 103 further informs the scanning module 102 to ignore the currently scanned downstream channel and hop to a next downstream channel to scan. If the currently scanned downstream channel is not in the black list 11, the black list determining module 103 further locks the currently scanned downstream channel.

The receiving module 104 receives transmission parameters and ranges of upstream channels, and locks one upstream channel to establish a connection with the CMTS 20 over the locked upstream channel and the locked downstream channel.

The obtaining module 105 comprises an address obtaining module 1051, a file obtaining module 1052, and a time obtaining module 1053. The obtaining module 105 is operable to obtain interconnection resources from the physical server 40, for establishing the bi-directional data communication between the cable modem 10 and the CMTS 20.

The address obtaining module 1051 communicates with the DHCP server 41 based on the connection with the CMTS 20, and obtains at least one IP address from the DHCP server 41. In one embodiment, the at least one IP address comprises an IP address of the cable modem 10, an IP address of the TFTP server 42, and an IP address the TOD server 43.

The address obtaining module 1051 further determines whether the at least one IP address is successfully obtained from the DHCP server 41. In response to unsuccessfully obtaining the at least one IP address, the address obtaining module 1051 ignores the locked downstream channel and records the locked downstream channel into the black list 11.

The file obtaining module 1052 communicates with the TFTP server 42 based on the IP address of the cable modem 10 and the IP address of the TFTP server 42, and obtains configuration files from the TFTP server 42.

The file obtaining module 1052 further determines whether the configuration files are successfully obtained from the TFTP server 42. In response to unsuccessfully obtaining the configuration files, the file obtaining module 1052 ignores the locked downstream channel and records the locked downstream channel into the black list 11.

Time obtaining module 1053 obtains time and date from the TOD server 43 for the cable modem 10. In one embodiment, the cable modem 10 and the CMTS 20 obtain time and date from the TOD server 43 to calibrate.

The register module 106 registers with the CMTS 20 in response to successfully obtaining the configuration files. The register module 106 further determines whether the register is successful or not. The register module 106 ignores the locked downstream channel and records the locked downstream channel into the black list 11 in response to the unsuccessful register. The cable modem 10 completes the channel scanning and establishes the bi-directional data communication in response to the successful register.

In one embodiment, the cable modem 10 scans channels fast, based on creation of the black list 11 to record the invalid downstream channels, and ignores the downstream channel in the black list 11 to avoid wasting time.

The description of the present disclosure has been presented for purposes of illustration and description, and is not intended to be exhaustive or limited to the disclosure in the form disclosed. Many modifications and variations will be apparent to those of ordinary skill in the art. Various embodiments were chosen and described in order to best explain the principles of the disclosure, the practical application, and to enable others of ordinary skill in the art to understand the disclosure for various embodiments with various modifications as are suited to the particular use contemplated.

What is claimed is:

1. A channel scanning method of a cable modem comprising:
scanning downstream channels from a cable modem terminal system (CMTS);
creating a black list which is a list that records invalid downstream channels of the downstream channels, wherein the invalid downstream channels comprise channels without enough interconnection resources to establish bi-directional data communications between the cable modem and the CMTS;
in response to a determination of the currently scanned downstream channel being in the black list, ignoring the currently scanned downstream channel and hopping to a next downstream channel to scan; or
in response to a determination of the currently scanned downstream channel not being in the black list, locking the currently scanned downstream channel, and establishing a connection with the CMTS over the locked downstream channel;
communicating with a dynamic host configuration protocol (DHCP) server based on the connection with the CMTS, and obtaining at least one Internet protocol (IP) address from the DHCP server; and
determining whether the at least one IP address is successfully obtained from the DHCP server; and
in response to unsuccessfully obtaining the at least one IP address, recording the locked downstream channel into the black list and hopping to a next downstream channel to scan.

2. The channel scanning method as claimed in claim 1, wherein the at least one IP address comprises an IP address of the cable modem and an IP address of a trivial file transfer protocol (TFTP) server.

3. The channel scanning method as claimed in claim 2, further comprising:
in response to successfully obtaining the at least one IP address, communicating with the TFTP server based on the IP address of the cable modem and the IP address of the TFTP server, to obtain configuration files from the TFTP server;
determining whether the configuration files are successfully obtained from the TFTP server;
in response to unsuccessfully obtaining the configuration files, recording the locked downstream channel into the black list and hopping to a next downstream channel to scan; or
in response to successfully obtaining the configuration files, registering with the CMTS based on the configuration files.

4. The channel scanning method as claimed in claim 3, further comprising:
determining whether the registering step is successful or not;
in response to a determination that the registering step is unsuccessful, recording the locked downstream channel into the black list and hopping to a next downstream channel to scan; or
in response to a determination that the registering step is successful, completing the channel scanning.

5. A cable modem, comprising:
at least one processor;
a storage system to store a black list, which is a list that records one or more invalid downstream channels, wherein the invalid downstream channels comprise channels without enough interconnection resources to establish bi-directional data communications between the cable modem and the CMTS; and
one or more programs that are stored in the storage system and executed by the at least one processor, the one or more programs comprising:
a scanning module to scan downstream channels from a cable modem terminal system (CMTS);
a black list determining module to determine whether a currently scanned downstream channel is in the black list or not, wherein in response to a determination of the currently scanned downstream channel being in the black list, the black list determining module informs the scanning module to ignore the currently scanned downstream channel and hop to a next downstream channel to scan, and else in response to a determination of the currently scanned downstream channel not being in the black list, the black list determining module locks the currently scanned downstream channel and establishes a connection with the CMTS over the locked downstream channel; and
an address obtaining module to communicate with a dynamic host configuration protocol (DHCP) server based on the connection with the CMTS, to obtain at least one Internet protocol (IP) address from the DHCP server;
wherein the address obtaining module further determines whether the at least one IP addresses is successfully obtained, and records the locked downstream channel into the black list and hops to a next downstream channel to scan in response to unsuccessfully obtaining the IP addresses.

6. The cable modem as claimed in claim 5, wherein the at least one IP addresses comprises an IP address of the cable modem and an IP address of a trivial file transfer protocol (TFTP) server.

7. The cable modem as claimed in claim 6, further comprising a file obtaining module to communicate with the TFTP server based on the IP address of the cable modem and the IP address of the TFTP server, and obtain configuration files from the TFTP server, and further to determine whether the configuration files are obtained successfully, and record the locked downstream channel into the black list and hop to a next locked downstream channel to scan in response to a determination that the configuration files being obtained unsuccessfully.

8. The cable modem as claimed in claim 7, further comprising a register module to register with the CMTS in response to a determination that the configuration files being obtained successfully, and further determine whether the register is successful, and record the locked downstream channel into the black list and hop to a next locked downstream channel to scan in response to a determination that the register is unsuccessfully, and complete the channel scanning in response to a determination that the register is successfully.
